(19) United States
(12) Patent Application Publication
(10) Pub. No.: US 2006/0007955 A1
(43) Pub. Date: Jan. 12, 2006

(54) Communication network capacity allocation method

(76) Inventor: Michael D. Kotzin, Buffalo Grove, IL (US)

Correspondence Address: MOTOROLA INC, 600 NORTH US HIGHWAY 45, ROOM AS437, LIBERTYVILLE, IL, 60048-5343, US

(21) Appl. No.: 10/885,184

(22) Filed: Jul. 6, 2004

(51) Int. Cl. H04J 3/16

(52) U.S. Cl. 370/467

(57) ABSTRACT

A method for allocating capacity in a communication network has steps of making a base offer to a remote device for allocation of network capacity in the communication network (210), receiving an acceptance of the base offer (220), determining utilization of capacity in the communication network (230), and making an extended offer to the remote device based on the determined utilization of capacity in the communication network (270). The extended offer can include options for increased quality of delivery, such as decreased latency of delivery, increased speed of delivery, or increased accuracy of delivery. The extended offer can include alternate features or formats for the delivery. The communication network capacity allocation method provides a way to increase service provider revenue by allocating, and charging for, otherwise unused network capacity. The method also gives customers opportunities to take advantage of excess network capacity—sometimes at a very good price.

### FIELD OF THE DISCLOSURE

This disclosure relates generally to communication networks, and specifically to allocating capacity of a communication network.

### BACKGROUND OF THE DISCLOSURE

Revenue management (or yield management) allocates products and services in a manner that maximizes profit or revenue. Revenue management helps a business sell the right products and services to the right customers at the right times and for the right prices. Businesses that benefit from revenue management generally share inventory characteristics of perishability, segmentability, and fixed capacity.

Perishability is when a product or service loses value or becomes unavailable after a certain time event. The nature of the product or service is such that unsold capacity is lost because it cannot be inventoried. For example, a vacant seat on a flight, an empty room in a hotel, and unused capacity in a communications network cannot be recovered and represents lost revenue opportunities.

Segmentability refers to the ability to segment customers based on a willingness to pay using different rates, different purchase or use restrictions, and other factors that may characterize an offer for products or services.

Fixed capacity refers to the inability to adapt available inventory volume at a reasonable cost and within a reasonable amount of time. For example, telephone companies, hotels, and airlines have a fairly fixed capacity. For fixed capacity businesses, there is an inability to increase available capacity at a given moment in order to satisfy a peak demand because even marginally increasing capacity implies a high cost. For example, a hotel may be overbooked during a specific time due to peak usage. The hotel cannot instantly increase the number of rooms to satisfy the customers' demand; adding an additional room means erecting another building to increase the overall capacity—which is not cost-effective when the peak usage is merely periodic or sporadic.

There is an opportunity to use revenue management techniques to allocate capacity in a communication network to increase the revenue and profit for communication service providers. The various aspects, features and advantages of the disclosure will become more fully apparent to those having ordinary skill in the art upon careful consideration of the following Drawings and accompanying Detailed Description.

### BRIEF DESCRIPTION OF THE DRAWINGS

FIG. 1 shows a communication network system architecture according to a preferred embodiment.

FIG. 2 shows a flow chart for allocating communication network capacity according to the preferred embodiment.

FIG. 3 shows examples of a base offer and extended offers according to the preferred embodiment.

### DETAILED DESCRIPTION OF THE PREFERRED EMBODIMENTS

A method for allocating capacity in a communication network has steps of making a base offer to a remote device for allocation of network capacity in the communication network, receiving an acceptance of the base offer, determining utilization of capacity in the communication network, and making an extended offer to the remote device based on the determined utilization of capacity in the communication network. The extended offer can include options for increased quality of delivery, such as decreased latency of delivery, increased speed of delivery, or increased accuracy of delivery. The extended offer can include alternate features or formats for the delivery. The communication network capacity allocation method provides a way to increase service provider revenue by allocating, and charging for, otherwise unused network capacity. The method also gives customers opportunities to take advantage of excess network capacity—sometimes at a very good price.

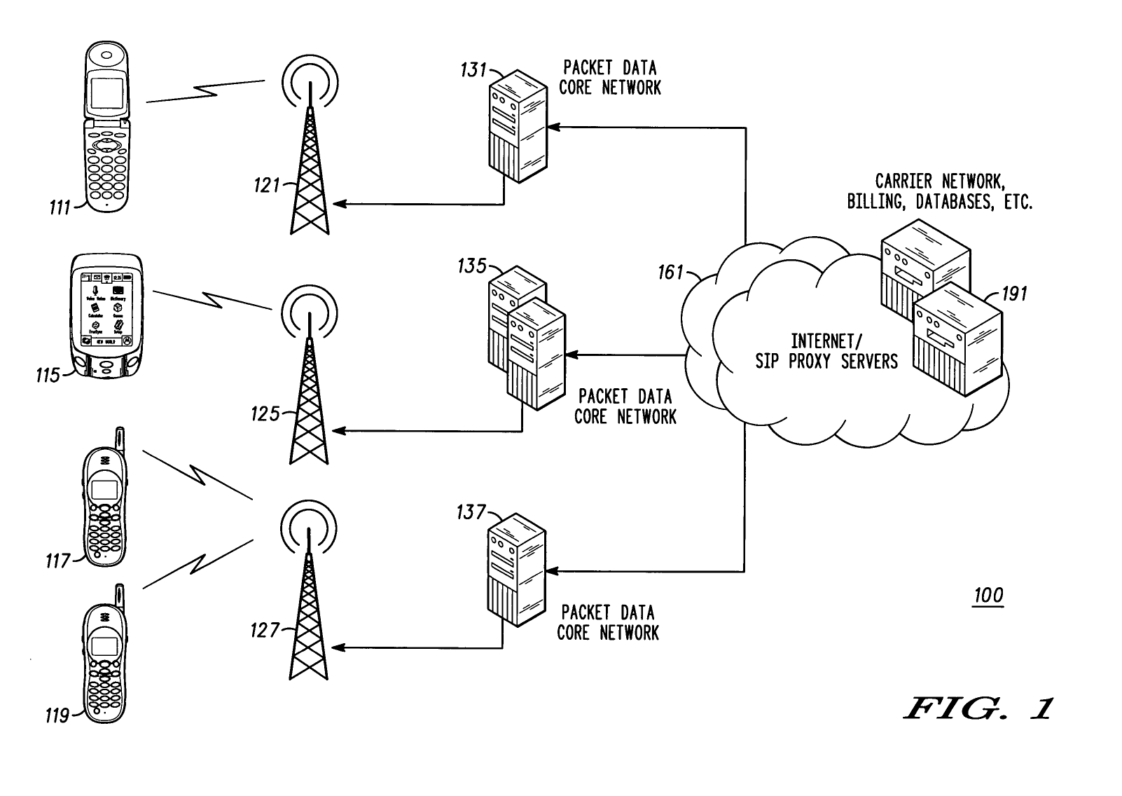

FIG. 1 shows a communication network system architecture 100 according to a preferred embodiment. This communication network uses a method to allocate its capacity to reduce wasting excess capacity and to increase the revenues and profits of the service provider operating the communication network. This system architecture 100 reflects a digital cellular telephone communication network, such as GSM/GPRS (Global System for Mobile Communications/General Packet Radio Service), GSM/EDGE (Global System for Mobile Communications/Enhanced Data Rates for Global Evolution), W-CDMA (Wideband Code Division Multiple Access, sometimes called Universal Mobile Telephony System (UMTS)), or cdma2000 and its variants. Other system architectures, including hybrids and future evolutions of the listed digital cellular telephone communication networks, may be substituted for the system architecture 100 shown.

In this system architecture 100, an originating remote device 111 wirelessly communicates with a radio access network 121. This radio access network 121 connects to a packet data core network 131 which in turn connects to the Internet 161, SIP (session initiation protocol) proxy servers, and other network elements 191 such as billing servers, databases, and other equipment. Other packet data core networks 135, 137 are connected to the Internet 161, while other radio access networks 125, 127 are connected to the packet data core networks as shown. Additional remote devices 115, 117, 119 are wirelessly connected to one or more of the available radio access networks 121, 125, 127.

In this preferred embodiment, the system architecture 100 is implemented as part of a GSM system, with the radio access networks being GSM/GPRS radio access networks and the packet data core networks 131, 135, 137 being Gateway GPRS Support Nodes (GGSNs) and Serving GPRS Support Nodes (SGSNs). As mentioned earlier, the system architecture 100 can alternately be implemented as part of a CDMA system, with the radio access networks 121, 125, 127 being CDMA 1× radio access networks and the packet data core networks 131, 135, 137 being Packet Data Switching Networks (PDSNs). The system architecture can have additional or alternate radio access networks and core networks, including combinations and hybrids that develop as technology progresses.

In this example, a remote device 111 wirelessly communicates with a radio access network 121. For the purposes of providing detail for this preferred embodiment, the remote device 111 is a GSM device and the radio access network 121 is a GSM/GPRS radio access network; however, alternate radio access networks are available as mentioned previously. The radio access network 125 connects to a packet data core network 135, implemented as an SGSN and GGSN, which in turn uses Internet Protocol (IP) to connect to the Internet 161.

Another remote device 115 wirelessly communicates with a different radio access network 125, which is also a GSM/GPRS radio access network. The radio access network 125 connects to a packet data core network 135, implemented as another SGSN and GGSN, which in turn uses an Internet Protocol (IP) to connect to the Internet 161. Further remote devices 117, 119 wirelessly communicate with yet another radio access network 127. The radio access network 127 connects to a packet data core network 137, which in turn connects to the Internet 161. Although the remote devices 111, 115, 117, 119 are shown as mobile telephones and a personal digital assistant, one or more remote devices could be implemented as other types of devices such as pocket personal computers or laptop computers.

If the remote devices 111, 115, 117, 119 are using approximately the same amount of network resources, the excess capacity of radio access network 121 should be greater than the excess capacity of radio access network 127. On the other hand, if remote device 111 is downloading a very large digital file while remote devices 117, 119 are merely in idle mode, the excess capacity of radio access network 121 could be less than the excess capacity of radio access network 127. Any excess network capacity can be allocated to customers, offered for sale, and used to bolster revenue for the service provider. Otherwise, it is likely that network capacity will be wasted, which would result in a lost opportunity for revenue. By taking advantage of this method, there is an opportunity to allocate network capacity in the form of radio resources of a wireless communication network.

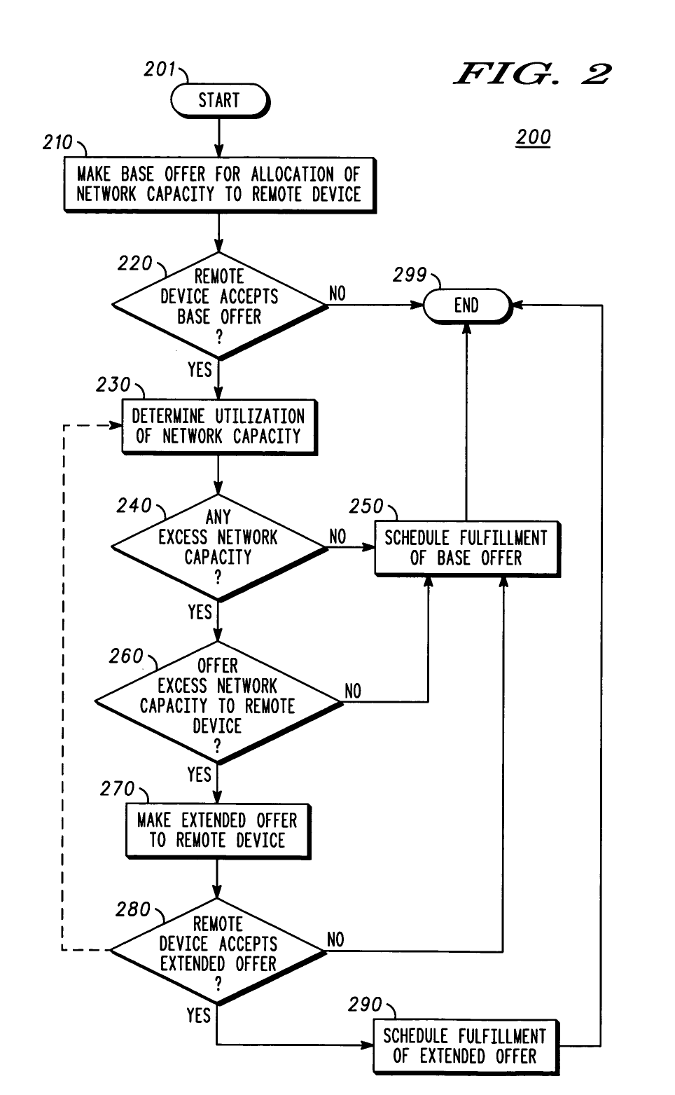

FIG. 2 shows a flow chart 200 for allocating communication network capacity according to the preferred embodiment. This flow chart 200 allocates network capacity to increase the revenues and profit of the service provider operating the network. After the start step 201, where a remote device, such as the remote device 111 shown in FIG. 1, makes a request for using network capacity, the network makes a base offer for allocation of network capacity to the remote device in step 210. This base offer can be predetermined, as a set cost or pricing, or it can be dynamically determined, depending on current or expected future transaction costs. The base offer can depend on a variety of factors such as the amount of data to be transferred, the time of the data transfer, and any priorities attached to the data (e.g., the data is being heavily marketed). If step 220 determines that the remote device does not accept the base offer, the flow chart ends in step 299.

If step 220 determines that the remote device accepts the base offer, the base offer is consummated and step 230 determines the utilization of network capacity. Excess network capacity, or unused network capacity, can be determined for the current time, for future times, or both. Excess network capacity can be determined for a portion of the network (e.g., the radio access network or the packet data core network) or the network as a whole. Because the radio resources in a radio access network are the most scarce for a wireless communication network, the preferred embodiment looks for unused network capacity at the radio resources level.

Step 240 queries whether there is any excess network capacity at the times of interest. In the preferred embodiment, the time period of interest begins at the time the base offer is accepted by the remote device and ends at the latest time the base offer will be fulfilled. If there is no excess network capacity at the times of interest, step 250 schedules fulfillment of the base offer and ends in step 299. Thus, the data will be transferred at the cost and timing agreed-upon in the base offer.

If step 240 determines that there is excess network capacity at the times of interest, step 260 queries whether the network should offer the excess network capacity to the particular remote device. This decision can be made dependant upon one or more factors such as historical information regarding offers of excess network capacity to that remote device, an affinity program based on frequency of usage of network capacity, or a priority toward a certain manufacturer of remote devices. The decision can also be a relative decision dependant upon how many other remote devices currently have base offers outstanding or accepted and their historical, affinity program, or other priority factors. If step 260 determines that a particular remote device should not receive an extended offer for excess network capacity, step 250 schedules fulfillment of the base offer before ending in step 299.

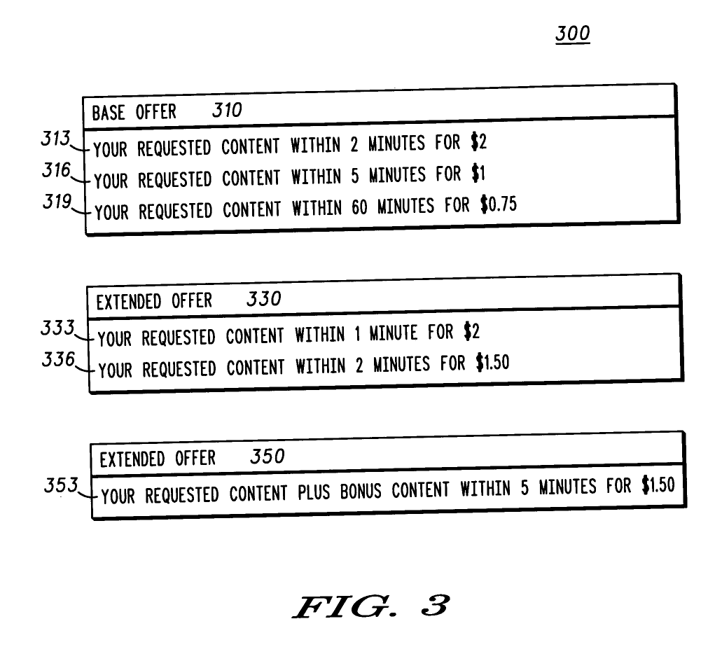

If step 260 determines that the remote device should receive an extended offer, step 270 makes the extended offer to the remote device. This extended offer can be a multi-layered offer with several choices and prices as will be explained in detail relative to FIG. 3.

If step 280 determines that the remote device does not accept the extended offer, step 250 schedules fulfillment of the base offer before ending in step 299. If step 280 determines that the remote device accepts the extended offer, step 290 schedules fulfillment of the extended offer before ending in step 290.

If there is further opportunity to offer network capacity, step 280 can return to step 230 to ascertain utilization of network capacity and determine whether to offer it to the remote device.

FIG. 3 shows examples 300 of a base offer and extended offers according to the preferred embodiment. Table 310 shows a sample base offer with three options 313, 316, 319. Although three options are shown, only one option is required. If there is only one option, there is no need for the table 310 to be shown at the remote device—especially if the base offer is an advertised offer with a predetermined cost and delivery parameters.

A base offer table can, however, be presented at the remote device as part of step 210 shown in FIG. 2. These options 313, 316, 319 can be predetermined, such as part of an advertised sale of downloadable digital content, or dynamically determined, such as through the real-time estimation of transaction costs for a particular piece of downloadable digital content. The options 313, 316, 319 shown are dependant upon the time interval before the downloading of the digital content will be complete (i.e., the latency of delivery). Other options can depend upon other factors, such as the quality of the downloaded digital content (e.g., a higher rate speech coder or a high resolution digital image), the features of the downloaded digital content (e.g., monophonic, stereophonic, or surround sound), the speed (or rate) of delivery of the downloaded digital content, the accuracy (or bit error rate) of the downloaded digital content, or the format of the downloaded digital content (e.g., JPEG, TIFF, PDF, or bitmap images). Another example of a “format” change would be to upgrade a teleconference to a videoconference with video images being updated at specified intervals or a further upgrade to a “real-time” videoconference. Still other options can be developed, limited only by the creativity of the marketers. For example, content with commercials could be downloaded for a lower price than commercial-free content.

The first option 313 states that, for $2, the requested content will be delivered within two minutes. The second option 316 states that, for $1, the requested content will be delivered within five minutes. The third option states that, for $0.75, the requested content will be delivered within sixty minutes. A selection of any of these three options 313, 316, 316 completes the remote device's acceptance of a base offer. See step 220 in FIG. 2.

Once the base offer is accepted, the network determines its utilization of network capacity and offers available network capacity in accordance with FIG. 2. Extended offers can come in a variety of forms, such as those shown in extended offer tables 330 and 350. Although two options are shown, only one option is required. If, for example, base offer option 319 was selected, table 330 could be offered to the remote device. A new option 333 states that, for $2, the requested content will be delivered within 1 minute. Another option 336, which is a variant of a previous base offer option 313, states that, for 1.50, the requested content will be delivered within two minutes. Note that, because the network has determined there will be excess network capacity in the next two minutes, the two-minute download can be offered for 1.50 instead of the original base offer of $2 for a two-minute download. This offer 336 creates a potential win-win situation for both the service provider and the customer. If the customer accepts option 336, the customer “saves” $0.50 compared to the base offer 313 (or only spends an additional $0.75 instead of spending an additional $1.25 for a two-minute download) while the service provider gets an additional $0.75 in revenue for network capacity that might otherwise be wasted.

The extended offer may present options that take human psychology into account, that optimize revenue based on historical information regarding usage of network capacity, that provide affinity rewards, that the reflect a supply-and-demand curve, or that use other factors or combinations of factors. For example, if the communication device frequently accepts extended offers, the method may re-determine utilization of network capacity (i.e., return to step 230 after step 280 in FIG. 2) and make additional extended offers more often than for a communication device that does not frequently accept extended offers. Also, a supply-and-demand curve would dictate that the price for network capacity is conversely related to the amount of network capacity available. Subsequent offers to different communication devices may reflect a previous communication device accepting an extended offer and thus reducing the amount of network capacity available for later communication devices and increasing the price for additional network capacity or even resulting in a determination of no available network capacity.

Extended offer table 350 provides only one option 353. In this scenario, the remote device has accepted base offer option 319 and has declined the extended offer table 330 in its entirety. The flow chart of FIG. 2 has gone from step 280 to step 230 to re-determine the utilization of network capacity and provide another extended offer. This extended offer is different than the previous offers, in that it does not depend wholly on the latency of delivery. Option 353 gives the option of bonus content as well as a specified latency of delivery.

Note that, although extended offer table 350 is described as being presented to the remote device after extended offer table 330 has been declined in its entirety, the table 350 could have been presented in lieu of table 330. Alternately, a second extended offer can be presented after a first extended offer has been accepted.

An advantage to this approach is that there is an opportunity to offer additional network capacity to a remote device that has already requested network capacity. By tailoring extended offers to established users of network capacity, there is an opportunity to increase revenues and profits associated with perishable inventory. This method also takes advantage of the segmentability of remote devices and their users. If capacity is available, there is an opportunity to offer the available network capacity to customers who are already interested in using network resources.

Although the preferred embodiment centers around maximizing revenue from excess network capacity, it is possible to use the method in other ways to maintain a desired load on the network. For example, an extended offer can provide rebates or future discounts to a user who is willing to reschedule or otherwise modify an accepted base offer. This type of extended offer would be advantageous in a situation when a network is unexpectedly at or over capacity.

Thus, the communication network capacity allocation method provides a way to increase service provider revenue by allocating, and charging for, otherwise unused network capacity. The method also gives customers opportunities to take advantage of excess network capacity—sometimes at a very good price.

While this disclosure includes what are considered presently to be the preferred embodiments and best modes of the invention described in a manner that establishes possession thereof by the inventors and that enables those of ordinary skill in the art to make and use the invention, it will be understood and appreciated that there are many equivalents to the preferred embodiments disclosed herein and that modifications and variations may be made without departing from the scope and spirit of the invention, which are to be limited not by the preferred embodiments but by the appended claims, including any amendments made during the pendency of this application and all equivalents of those claims as issued.

It is further understood that the use of relational terms such as first and second, top and bottom, and the like, if any, are used solely to distinguish one from another entity, item, or action without necessarily requiring or implying any actual such relationship or order between such entities, items or actions. Much of the inventive functionality and many of the inventive principles are best implemented with or in software programs or instructions. It is expected that one of ordinary skill, notwithstanding possibly significant effort and many design choices motivated by, for example, available time, current technology, and economic considerations, when guided by the concepts and principles disclosed herein will be readily capable of generating such software instructions and programs with minimal experimentation. Therefore, further discussion of such software, if any, will be limited in the interest of brevity and minimization of any risk of obscuring the principles and concepts according to the present invention.

We claim:

1. A method for allocating capacity in a communication network comprising the steps of:
making a base offer to a remote device for allocation of network capacity in the communication network;
receiving an acceptance of the base offer;
determining utilization of capacity in the communication network; and
making an extended offer to the remote device based on the determined utilization of capacity in the communication network.

2. A method according to claim 1, further comprising the steps of:
receiving an acceptance of the extended offer; and
scheduling fulfillment of the extended offer.

3. A method according to claim 1, further comprising the steps of:
receiving an acceptance of the extended offer;
redetermining utilization of capacity in the communication network; and
making a next extended offer to the remote device.

4. A method according to claim 1, further comprising the steps of:
receiving a rejection of the extended offer; and
scheduling fulfillment of the base offer.

5. A method according to claim 1, further comprising the steps of:
receiving a rejection of the extended offer;
re-determining utilization of capacity in the communication network; and
making a next extended offer to the remote device.

6. A method according to claim 1, wherein the step of determining utilization of capacity comprises:
determining whether any excess network capacity is available at times of interest.

7. A method according to claim 6, wherein times of interest start at a time of receiving an acceptance of the base offer and end at a latest time when the base offer will be fulfilled.

8. A method according to claim 6, wherein the step of making an extended offer comprises:
deciding whether to offer excess network capacity to the remote device, if excess network capacity is available at times of interest.

9. A method according to claim 8, wherein the step of making an extended offer further comprises:
offering excess network capacity to the remote device, if excess network capacity is available at times of interest.

10. A method according to claim 1, further comprising the step of:
scheduling fulfillment of the base offer, if the remote device does not accept the extended offer.

11. A method according to claim 1, wherein the extended offer includes an offer to increase quality of delivery.

12. A method according to claim 11, wherein the increased quality of delivery includes a decrease in latency of delivery.

13. A method according to claim 11, wherein the increased quality of delivery includes an increase in speed of delivery.

14. A method according to claim 11, wherein the increased quality of delivery includes an increase in accuracy of delivery.

15. A method according to claim 1, wherein the extended offer includes an offer to provide alternate formats for delivery.

16. A method according to claim 1, wherein the extended offer includes an offer to provide additional features for delivery.

17. A method comprising:
consummating a base offer negotiation for allocating a radio resource to a subscriber terminal in a communication network;
determining availability of network capacity in the communication network; and
negotiating for an allocation of an additional radio resource to the subscriber terminal, for use with the base offer, if network capacity is available in the communication network.

18. A method according to claim 17, wherein the step of negotiating comprises:
negotiating for an allocation of the additional radio resource to the subscriber terminal based on an amount of unused network capacity available in the communication network.

19. A method according to claim 17, wherein the step of negotiating comprises:
negotiating for an allocation of the additional radio resource to the subscriber terminal based on previous radio resource negotiation information between the communication network and the subscriber terminal.

20. A method according to claim 17, wherein the step of determining comprises:
determining availability of the network capacity for a period during which the radio resource allocation previously negotiated will be utilized by the subscriber terminal.
